(19) United States
(12) Patent Application Publication
(10) Pub. No.: US 2014/0313441 A1
(43) Pub. Date: Oct. 23, 2014

(54) DISPLAY DEVICE

(71) Applicant: Samsung Electronics Co., Ltd., Suwon-si (KR)

(72) Inventor: Sil-Kyu LIM, Suwon-si (KR)

(73) Assignee: Samsung Electronics Co., Ltd., Suwon-si (KR)

(21) Appl. No.: 14/258,618

(22) Filed: Apr. 22, 2014

(30) Foreign Application Priority Data
Apr. 22, 2013 (KR) 10-2013-0044045

(51) Int. Cl. G06F 3/041

(52) U.S. Cl. CPC G06F 3/041
USPC 349/12

(57) ABSTRACT

A display device is provided. The display device includes a display panel configured to output a screen, at least one optical member configured to make the screen output from the display panel pass therethrough, and an optical attachment layer configured to attach the optical member to the display panel. The optical attachment layer is colored and transparent.

### CROSS-REFERENCE TO RELATED APPLICATION(S)

This application claims the benefit under 35 U.S.C. §119(a) of a Korean patent application filed on Apr. 22, 2013 in the Korean Intellectual Property Office and assigned Serial number 10-2013-0044045, the entire disclosure of which is hereby incorporated by reference.

### TECHNICAL FIELD

The present disclosure relates to an electronic device. More particularly, the present disclosure relates to a display device mounted on a mobile communication terminal or the like.

### BACKGROUND

A display device may be a device applied to various electronic devices, such as televisions, computer monitors and mobile communication terminals, so as to output various information pieces on a screen. The commercial use of flat display devices has made it possible to mount a display device which has been mainly used in a home or office equipment on a small portable electronic device, such as a mobile communication terminal The flat display devices are usually configured using a display panel such as a Liquid Crystal Display (LCD), a Plasma Display Panel (PDP), or an Organic Light Emitting Diode (OLED) display. The LCD is configured to generate an image by driving a liquid crystal which is an anisotropic material. When light provided from a backlight unit penetrates the LCD, a user may recognize a screen displayed on the display panel.

A color of the screen output from the display device is determined substantially by a combination of an output of the display, a color filter, and light provided from a light source. When implementing such a color, a white balance may also be secured by fabricating the backlight unit by selecting a light source manufactured according to the display panel and the color filter thereof.

Meanwhile, in an electronic device equipped with the display device, the display device consumes a considerable amount of the power consumed by the electronic device. This is because a large amount of power is required for driving the display panel and providing the illumination of the display panel. Further, in a case of an electronic device which is used while being carried by a user, such as a mobile communication device, since a capacity of the power source, i.e., a battery capacity, is limited, reduction of power consumed by the display device is desired.

In addition, high image quality competition is also growing in portable electronic devices and users demand brighter and clearer screens. Through the efficient arrangement of internal space of the portable electronic devices, capacity of batteries have increased but not to the degree of which power consumption has increased due to the improved performance of display devices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a display device which may improve power consumption efficiency.

Another aspect of the present disclosure is to provide a display device which may reduce manufacturing costs.

Another aspect of the present disclosure is to provide a display device which may improve flexibility in designing colors of an output screen.

In accordance with an aspect of the present disclosure, a display device is provided. The display device includes a display panel configured to output a screen, at least one optical member configured to make the screen output from the display panel pass therethrough, and an optical attachment layer configured to attach the optical member to the display panel, wherein the optical attachment layer is colored and transparent.

In accordance with an aspect of the present disclosure, a display device is provided. The display device includes a display panel configured to output a screen, at least one optical member disposed on the display panel, the at least one optical member being transparent to the screen output from the display panel, and an optical attachment layer disposed between the optical member and the display panel, wherein the optical attachment layer is colored so as to have a color tint.

As described above, a display device according to the present disclosure may use a high luminance light source in order to set a white balance since a color additive is contained in an optical attachment layer. The high luminance light source may exhibit a same luminance as that obtained using a low luminance light source and may consume less power compared to the low luminance light source. As a result, it is possible to reduce the power consumed by the display device using the high luminance light source. A high luminance light emitting diode may be manufactured more easily with a higher yield as compared with a low luminance light emitting diode due to its manufacturing characteristics. Thus, when the high luminance light emitting diode is used as the light source which provides backlighting, manufacturing costs of the display device may be reduced. Further, when adjusting a setting of a manufactured display panel, for example, adjusting a white balance, the white balance may be variously set by controlling a content of a color additive contained in the optical attachment layer. Therefore, flexibility in designing the display device may be enhanced.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a configuration of a display device according to an embodiment of the present disclosure;

FIG. 2 is a view for describing a configuration of the display device illustrated in FIG. 1 in more detail according to an embodiment of the present disclosure; and

FIG. 3 is a view for describing a modified example of the display device illustrated in FIG. 1 according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A display device according to an embodiment of the present disclosure includes a configuration in which a transparent colored optical attachment layer is disposed between a display panel and an optical member. The optical member is provided so as to protect the display panel while transmitting a screen output from the display panel. The optical member includes a window positioned at the outermost of the display device, various optical films interposed between the window and the display panel, and an Indium-Tin Oxide (ITO) film that provides a touch screen function.

As described below, the optical attachment layer is configured to be transparent while being colored by containing a color additive. A color temperature of the light passing through the optical member, more specifically, the optical attachment layer, will increase. In a display device to which the optical attachment layer is applied, a value of a white balance may be made close to a design value through various methods. For example, a display device according to an embodiment of the present disclosure may adjust the white balance thereof by using a high luminance light emitting diode as a light source. When a luminance needed by the display device is constant, a desired luminance may be obtained with less power consumption by using a high luminance light emitting diode.

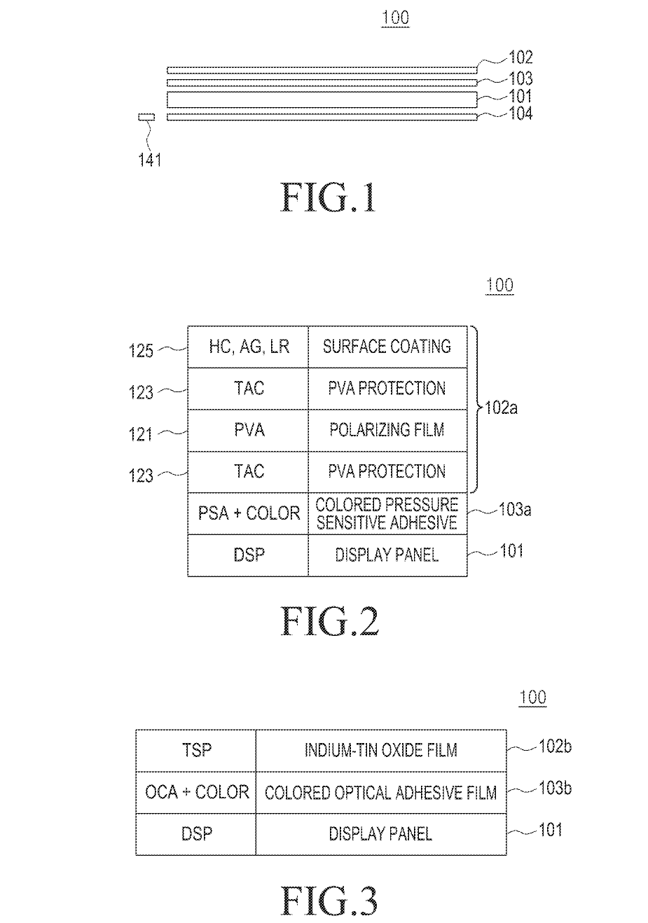

FIG. 1 illustrates a configuration of a display device according to an embodiment of the present disclosure; and FIG. 2 is a view for describing the configuration of the display device illustrated in more detail according to an embodiment of the present disclosure.

Referring to FIGS. 1 and 2, a display device 100 includes a display panel 101, an optical member 102, and an optical attachment layer 103 and may be provided with a backlight unit configured by a light source 141 and a light guide plate 104 in order to provide illumination. The light source 141 is positioned at an edge of one side on a rear surface of the display panel 101, but a plurality of light sources may be arranged at a predetermined interval to face a rear side of the display panel 101. In this case, the light guide plate 104 may not be needed.

The display panel 101 may be a flat display panel, such as a Liquid Crystal Display (LCD) panel, a plasma display panel, an Organic Light Emitting Diode (OLED) display panel, and/or any other similar and/or suitable flat display panel type and/or device, and will output a screen.

The optical member 102 transmits the screen output from the display panel 101 and at least one of the optical member 102 may be disposed on, and/or laminated on, the display panel 101. Accordingly, the optical member 102 may be disposed on, and/or directly attached to, the display panel 101 and/or adhered to any other optical member on the display panel 101. The optical member 102 includes a transparent window made of a glass and/or a synthetic polymer resin and an optical compensation film that corrects a phase difference of the screen output from the display panel 101. When the display device 100 has a touch screen function, an ITO film that senses, for example, a user's touch position, also corresponds to the optical member 102. The optical attachment layer 103 is manufactured to be transparent while being colored, or in other words, tinted so as to have a color tint, by containing a color additive when manufactured.

Referring to FIG. 2, an optical compensation film 102a, for example, a polarizing film, as the optical member 102 is illustrated.

The optical compensation film 102a has a configuration in which Tri-Acetyl Cellulose (TAC) films 123 are respectively attached to both sides of a PolyVinyl Alcohol (PVA) film 121 that provides a polarizing function, and a surface side TAC film 123 is protected by a surface coating layer 125. The PVA film 121 may be disposed on each of front and rear sides of a display panel, such as an LCD, so as to provide the polarizing function. The TAC films 123 are respectively attached to front and rear sides of the PVA film 121 to prevent the PVA film 121 from being damaged. The surface coating layer 125 is a layer positioned on a surface of the optical compensation film 102a so as to improve a durability, an anti-scratch property, an optical characteristic, or the like. For example, when the surface coating layer 125 is formed of a Hard Coating (HC), the durability and/or the anti-scratch property may be improved. In addition, when an Anti-Reflective (AR) coating layer, a Low-Reflective (LR) coating layer, an Anti-Glare (AG) coating layer, or the like is formed as the surface coating layer 125, optical characteristics, such as a viewing angle and visibility of the optical compensation film 102a, may be enhanced, and hence, the display device 100 can be enhanced. A PolyEthylene Terephthalate (PET) film and a Cyclo Olefin Polymer (COP) film may be attached instead of the surface coating layer 125.

The optical attachment layer 103 transmits the screen output from the display panel 101, and allows the optical member 102 to be attached to display panel 101, for example, to a surface of the display panel 101. When the display device 100 is arranged in an electronic device, the display panel 101 and the window, as mentioned above, may be arranged to be spaced apart from each other. At this time, the optical member 102 may be attached to the window. In other words, it is not always necessary to attach the optical member 102 to the display panel 101.

The optical attachment layer 103 may be made of a Pressure Sensitive Adhesive (PSA) and/or an optical adhesive film. FIG. 2 illustrates a configuration in which the optical attachment layer 103 is formed using a PSA 103a to attach the optical compensation film 102a to the display panel 101. The PSA film 103a forming the optical attachment layer 103 is manufactured to be transparent while being colored by containing a color additive when manufactured. In a state where the PSA 103a, which is colored and transparent, is coated on the display panel 101 and/or on the optical compensation film 102a, the display panel 101 and the optical compensation film 102a are attached to face each other, and the PSA 103a is cured by ultraviolet curing or thermal curing.

FIG. 3 illustrates an ITO film 102b as the optical member 102 according to an embodiment of the present disclosure. The ITO film 102b has a configuration in which a plurality of transparent electrodes are arranged. When a user touches the screen, the ITO film 102b senses the user's touch and generates an input signal according to the user's touch. FIG. 3 illustrates a configuration in which the ITO film 102b is attached to the display panel 101 according to an embodiment of the present disclosure. However, the present disclosure is not limited thereto, and the ITO film 102b may be attached to the window to be spaced apart from the display panel 101.

FIG. 3 illustrates a configuration in which the optical attachment layer 103 is made of an optical adhesive film 103b. The optical adhesive film 103b is manufactured to be colored and transparent by containing a color additive, and allows the ITO film 102b to be adhered to the display panel 101.

The optical attachment layer 103 is configured to transmit a light ray of visible light that is within a visible ray region, that is, a light ray having a wavelength ranging from 380 nm to 800 nm so that the screen output from the display panel 101 passes through the optical attachment layer 103.

The following Table 1 presents optical characteristic values measured in a case where both a related-art display device and a display device according to the present disclosure are equipped with the same light sources, for example, Light Emitting Diodes (LEDs).

TABLE 1

| | | | | | Color | Correlated |
|---|---|---|---|---|---|---|
| | | | | | Repro- | Color |
| | Color Coordinates of White | | | | duction | Temperature |
| | Balance (CIE Rank) | | | | (NTSC) | (CCT) |
| | x | y | u′ | v′ | (Unit: %) | (Unit: K) |
| Design | 0.3040 | 0.3300 | 0.191 | 0.468 | 70.8 | 7500 |
| Standard | | | | | | |
| Related- | 0.2890 | 0.3270 | 0.183 | 0.464 | 75.0 | 7990 |
| Art | | | | | | |
| Disclosure | 0.2872 | 0.3251 | 0.182 | 0.462 | 75.5 | 8170 |

Upon comparing the related-art display device to the display device according to the present disclosure, the display device according to the present disclosure is formed with an optical attachment layer 103 containing a color additive and, thus, increases the Correlated Color Temperature (CCT) of the screen output from the display device 100 by about 180K, without suffering from substantial change of color reproduction. Through such change of color temperatures, bluish colors may be strengthened by the optical attachment layer 103. Accordingly, in order to make the color temperature, and/or the like, of the display device provided in the optical attachment layer 103 close to a design standard, an additional color filter may be used and/or a luminance of the light source may be increased. In other words, when a LED is used as the light source 141, the display device, according to the present disclosure, may adjust a change of the white balance caused by the optical attachment layer 103 to be close to the design standard by using a high luminance LED.

In Table 1, color coordinates of the white balance, which may also be referred to as an International Commission on Illumination (CIE) rank, are reduced by the optical attachment layer 103, i.e., are shifted toward bluish colors. In order to make reduction and/or shift close to the design standard, a high luminance LED, for example, a yellow LED may be used. When the light source 141 is configured by the high luminance LED, the same luminance as that obtained using a light source configured by a low luminance LED may be obtained with less power consumption. In addition, as compared with the low luminance LED, the yellow high luminance LED is excellent in terms of manufacturing yield. Thus, it is possible to reduce material costs and, thus, save on manufacturing costs. In addition, since limitations in relation to a content of the color additive contained in the optical attachment layer 103, a luminance of the light source 141, and/or the like are reduced, the flexibility in designing the display device 100 may be enhanced.

When a LCD panel is used as the display panel 101, a light source may be freely selected so as to configure the display device 100 when the optical attachment layer 103 is configured to be colored and transparent as described above.

Meanwhile, when the display panel is configured using an OLED including an active OLED, the display panel emits light by itself Thus, a separate light source may not be provided. However, when the colored transparent optical attachment layer 103, as described above, is disposed, a more clear black color may be displayed on a display panel using the OLED. In other words, when the optical attachment layer 103 is fabricated to be black and transparent, the black color of the display panel 101 may be displayed, i.e., implemented, more deeply and clearly. Alternatively, when the optical attachment layer 103 is fabricated to be black and transparent, strengthening of the phosphor luminance of colors other than the black color, for example, red, green, and blue is needed. When the phosphor luminance of Red/Green/Blue (R/G/B) is strengthened depending on the concentration of the optical attachment layer 103, a same luminance and/or chromaticity may be maintained while reducing the power used for implementing, i.e., displaying, at least the R/G/B, and, the black color, to implement a clearer color sense, i.e. a deeper and darker color sense.

While the present disclosure has been shown and described with reference to certain various embodiments thereof, it will be understood by those skilled in the art that various changes in form and details may be made therein without departing from the spirit and scope of the present disclosure as defined by the appended claims and their equivalent.

What is claimed is:

1. A display device comprising:
a display panel configured to output a screen;
at least one optical member configured to make the screen output from the display panel pass therethrough; and
an optical attachment layer configured to attach the optical member to the display panel,
wherein the optical attachment layer is colored and transparent.

2. The display device of claim 1, wherein the optical attachment layer is configured to be made of a Pressure Sensitive Adhesive (PSA).

3. The display device of claim 1, wherein the optical attachment layer is configured to be an optical adhesive film.

4. The display device of claim 1, wherein the optical attachment layer is configured to transmit light having a wavelength ranging from 380 nm to 800 nm.

5. The display device of claim 1, wherein the optical member is configured to be a polarizing film which is made of polyvinyl alcohol.

6. The display device of claim 5, wherein the optical attachment layer is configured to be made of a Pressure Sensitive Adhesive (PSA).

7. The display device of claim 6, further comprising a protective film disposed on at least one surface of the optical member and interposed between the optical member and the optical attachment layer.

8. The display device of claim 7, further comprising a surface coating layer formed on at least one other surface of the optical member.

9. The display device of claim 8, wherein the surface coating layer is configured to be at least one of a hard coating layer, an anti-reflective coating layer, a low-reflective coating layer, and an anti-glare coating layer.

10. The display device of claim 1, wherein the optical member is configured to be an Indium-Tin Oxide (ITO) film that provides a touch screen function.

11. The display device of claim 10, wherein the optical attachment layer is configured to be an optical adhesive film.

12. The display device of claim 1, wherein the optical attachment layer includes a color additive in order to be colored and transparent.

13. The display device of claim 1, wherein the display panel is configured to be a Liquid Crystal Display (LCD) panel, and
wherein a white balance is set by a color combination of light emitted from the light source provided adjacent to the display panel and light emitted from the optical member.

14. The display device of claim 1, wherein the display panel is configured to be made of an Organic Light Emitting Diode (OLED), and
wherein a white balance is set by a color combination of light emitted from a phosphor of the display panel and the color of the optical attachment layer.

15. A display device comprising:
a display panel configured to output a screen;
at least one optical member disposed on the display panel, the at least one optical member being transparent to the screen output from the display panel; and
an optical attachment layer disposed between the optical member and the display panel,
wherein the optical attachment layer is colored so as to have a color tint.

16. The display device of claim 15, wherein the optical member is configured to be an Indium-Tin Oxide (ITO) film that provides a touch screen function.

17. The display device of claim 15, wherein the optical attachment layer is configured to be one of an optical adhesive film and a Pressure Sensitive Adhesive (PSA).

18. The display device of claim 15, wherein the optical attachment layer is configured to be transparent to light having a wavelength ranging from 380 nm to 800 nm.

19. The display device of claim 15, wherein the display panel is configured to be a Liquid Crystal Display (LCD) panel,
wherein the display device further comprises a light guide plate disposed below the display panel and a light source providing light to the light guide plate, and
wherein a white balance is set by a color combination of light emitted from the light source provided adjacent to the display panel and light emitted from the optical member.

20. The display device of claim 15, wherein the display panel is configured to be made of an Organic Light Emitting Diode (OLED), and
wherein a white balance is set by a color combination of light emitted from a phosphor of the display panel and the color of the optical attachment layer.
